(19) United States
(12) Patent Application Publication
(10) Pub. No.: US 2018/0048041 A1
(43) Pub. Date: Feb. 15, 2018

(54) Tri-Electrode Zinc-Air Battery with Flowing Electrolyte

(71) Applicants: Zhongwei CHEN, Waterloo (CA); Hao LIU, Waterloo (CA)

(72) Inventors: Zhongwei CHEN, Waterloo (CA); Hao LIU, Waterloo (CA)

(21) Appl. No.: 15/555,668

(22) PCT Filed: Mar. 4, 2016
(86) PCT No.: PCT/CA2016/050239

§ 371 Date: Sep. 5, 2017

Related U.S. Application Data
(60) Provisional application No. 62/177,019, filed on Mar. 4, 2015.

(51) Int. Cl. H01M 12/02; H01M 4/38; H01M 12/08

(52) U.S. Cl. CPC H01M 12/02; H01M 12/08; H01M 4/38; H01M 2004/8689

(57) ABSTRACT

A rechargeable tri-electrode single flow zinc air battery which is capable of providing theoretically unlimited cycle life is provided. The tri-electrode configuration consists of one anode and two cathodes, one for charging and another for discharging. The charge cathode may comprise a water-permeable metal mesh and/or metal foam, which avoids carbon corrosion. The discharge cathode is a catalytic oxygen reduction electrode. The anode comprises an inert, conductive electrode allowing for zinc deposition during battery charging, and zinc dissolving during battery discharging. The flowing electrolyte removes zinc ions from the anode preventing or minimizing the formation of zinc oxides during discharging, and clean the anode after each full discharge.

### CROSS REFERENCE TO PRIOR APPLICATIONS

The present application claims priority under the Paris Convention to U.S. Application No. 62/177,019, filed Mar. 4, 2015, the entire contents of which are incorporated herein by reference.

### FIELD OF THE DESCRIPTION

The present description relates to the field electrochemical energy conversion and storage devices and its applications. In particular, the invention relates to an improved rechargeable zinc-air (or zinc-oxygen) battery that includes three electrodes and a flowing electrolyte.

### BACKGROUND

Rechargeable zinc air batteries are a highly promising technology due to a number of advantages. For example, a zinc air battery utilizes oxygen from atmospheric air, which has no cost and is virtually inexhaustible and eliminates the need to store a fuel source within the battery. Furthermore, catalysts utilized in zinc-air batteries electrochemically reduce oxygen, but are not used in the actually current generating reaction, which makes it theoretically possible for them to function for an unlimited period of time. In addition, a zinc-air battery uses oxygen and zinc as the active materials and is therefore affordable, safe and environmentally friendly. However, there remain two major technical issues which hamper the commercialization of rechargeable zinc-air batteries.

The first issue is the corrosion of carbon contained in the cathode, which occurs during the charging phase of the battery. In conventional rechargeable zinc air batteries, the charge and discharge cycles utilize the same cathode, which comprises a porous carbon material on which are supported the required catalysts. These cathodes play an important role for the oxygen evolution reaction (OER) and the oxygen reduction reaction (ORR) of the battery. In the process, a side reaction occurs wherein the carbon is corroded during the OER. In particular the carbon is oxidized into CO₂. Once the carbon carriers oxidize and disappear, the catalysts supported on carbon lose contact with the electrode, which makes them ineffective, resulting in the fading of the battery's performance.

The second issue associated with conventional zinc-air batteries is the shape change that occurs at the anode and the formation of zinc dendrites also on the anode side. In conventional rechargeable zinc-air batteries, during the discharging phase, zinc particles on the anode are oxidized into zinc ions and move into the electrolyte. These ions are then deposited as zinc oxide particles almost at the same time because of the poor solubility of zinc ions in the alkaline electrolyte. During the charging phase, zinc oxide particles transform into zinc particles. These zinc particles may shift downward because of gravity during long period cycling, and this may cause a change in the shape of the anode. The zinc particles may also form zinc dendrites on the anode. The change in the shape of the anode may lead to energy fading, and the zinc dendrites may cause sudden death of the battery.

Examples of a zinc-air batteries are provided in US2015/0010833 and CN 101783429.

US2015/0010833 teaches a two electrode Zn-air battery that, while providing an improvement, still suffers from some of the issues known in the art.

CN 101783429 teaches an alkaline single flow zinc-O₂ battery, where a flowing electrolyte was utilized to remove zinc ions from the anode so as to avoid the partial saturation of zinc ions and the formation of zinc oxides during the battery discharge phase. The battery taught in this reference utilizes a bi-functional cathode but still comprises a two electrode cell. This reference does not address the issue of carbon corrosion. The battery taught in this reference is therefore not suitable for long-term use.

Yanguang Li et al. (Y. Li et al., Advanced Zinc-Air Batteries Based on High-Performance Hybrid Electrocatalysts; Nature Comm., 4:1805, 2013, DOI: 10.1038) teach a tri-electrode zinc-air battery, wherein improvements were made to the catalysts used in the ORR and OER reactions. This reference teaches a battery that utilizes a zinc plate as the anode and does not have a flowing electrolyte. The battery lasted for only 200 hours and is therefore not suitable for long-term use.

There exists a need for a zinc-air (or zinc-oxygen) battery which addresses at least some of the issues described above and which is preferably adapted for long-term functionality.

### SUMMARY OF THE DESCRIPTION

The present description provides a tri-electrode rechargeable zinc air battery which aims to solve the aforementioned issues that occur on the cathode and the anode with conventional rechargeable zinc-air batteries.

The description provides a battery having a tri-electrode configuration with one anode and two kinds of cathodes. One cathode serves the purpose of charging and the other serves the purpose of discharging. The charge cathode for oxygen evolution preferably comprises an electrolyte permeable, alkaline-resistant metal mesh/foam electrode. The discharge cathode for oxygen reduction preferably comprises a conductive, air-permeable but water-proof catalytic electrode. The use of two different functional cathodes has been found by the present inventors to solve the problem of carbon corrosion and the loss of catalysts during battery charging of a bi-functional cathode used in conventional rechargeable zinc air batteries. The battery described herein exhibits a much longer operating lifespan.

The anode described herein comprises an inert, conductive electrode, wherein zinc is deposited on its surface during the battery charging phase, and zinc is dissolved from its surface during the battery discharge phase.

The battery described herein includes a flowing electrolyte, which removes zinc ions away from the anode to avoid partial saturation of zinc ions and the formation of zinc oxides during the battery discharge phase. In this manner, the surface of anode is “cleaned” by the flowing electrolyte and is maintained at or close to its “fresh” state after every full discharge. This therefore avoids the forming of zinc dendrites and the associated drawbacks.

Thus, in one aspect, there is provided a zinc-oxygen battery comprising:
a housing containing at least one discharge cathode, at least one charge cathode, and at least one anode;
an electrolyte adapted to flow through the housing, the electrolyte comprising an alkaline solution containing at least one zinc salt dissolved therein;
the charge cathode comprising a non-carbon metal mesh and/or metal foam material;
the electrolyte being adapted to flow over at least the surface of the anode

### BRIEF DESCRIPTION OF THE FIGURES

The features of certain embodiments will become more apparent in the following detailed description in which reference is made to the appended figure wherein:

FIG. 1 is a schematic configuration of a tri-electrode zinc air battery according to an aspect of the description as illustrated in Example A.

FIG. 2 shows the voltage curves at various charging and discharging current densities of the battery of Example A.

FIG. 3 shows the cycle performance characteristics of the battery of Example A.

### DETAILED DESCRIPTION

In the present description, reference will be made to a zinc-air battery or a zinc-oxygen battery. Such batteries will be known to persons skilled in the art and it will be understood that the terms “zinc-air” and “zinc-oxygen” may be used interchangeably with reference to the same battery.

The terms “comprise”, “comprises”, “comprised” or “comprising” may be used in the present description. As used herein (including the specification and/or the claims), these terms are to be interpreted as specifying the presence of the stated features, integers, steps or components, but not as precluding the presence of one or more other feature, integer, step, component or a group thereof as would be apparent to persons having ordinary skill in the relevant art.

Described herein is a tri-electrode (i.e. three-electrode) single flow zinc-air battery comprises a housing containing at least one discharge cathode, at least one charge cathode, at least one anode, and an electrolyte. The battery includes or is associated with an electrolyte flow system comprising an electrolyte storage tank or reservoir, a pumping apparatus, manifold(s) and other piping components, to allow flow of the electrolyte between the reservoir and the housing.

The discharge cathode preferably comprises a conductive, air-permeable but waterproof catalytic oxygen reduction electrode.

The charge cathode preferably comprises an electrolyte permeable, alkaline-resistant metal mesh and/or metal foam electrode. Preferably, the charge cathode is made of a material selected from nickel, nickel alloy, titanium, titanium alloy, stainless steel, or a mixture or combination thereof. Carbon is not used for the charge cathode, thereby avoiding the issue of carbon corrosion discussed above.

The anode comprises an inert, conductive electrode where zinc deposition occurs during battery charging, and zinc dissolving occurs during battery discharging. The anode may comprise a foil, sheet, plate, or foam. The anode material may be selected from carbon/graphite based material, stainless steel, Sn, Pb, Cu, Ag, Au, Pt, alloys thereof, and any combination or mixture thereof.

The electrolyte preferably comprises an alkaline solution (0.3-15 M of OH⁻) containing at least one or more soluble zinc salts. Preferably, such salts are selected from ZnO, Zn(OH)₂, K₂Zn(OH)₄, Na₂Zn(OH)₄, or any combination thereof. The concentration of the salt(s) in the electrolyte is preferably 0.1-1.5 M.

In one aspect, the battery may be assembled such that: (1) one side of the discharge cathode is exposed to air, and the other side is exposed to the electrolyte; (2) the charge cathode is placed between the discharge cathode and anode; (3) the electrolyte flow system pumps the electrolyte so as to flow between the cell and tank during battery charging and discharging.

The tri-electrode single flow zinc-air battery described herein, adapts a strategy combination of “tri-electrode”, “carbonless charge cathode”, “inert anode” and “electrolyte flow system”. This strategic combination of electrodes and battery components solves two major technical issues: the carbon corrosion of the cathode, and the shape changing and zinc dendrite formation on the anode, and makes the battery able to a theoretically have an unlimited service time, making it very promising for grid energy storage applications.

Carbon corrosion on the cathode mainly happens during battery charging. By using a tri-electrode configuration as described herein, and by using a carbonless metal mesh/foam material as the charging electrode, the issue of carbon corrosion is obviated.

The combination of an inert anode and an electrolyte flow system in the presently described battery addresses the shape change and zinc dendrite formation issues that occur at the anode. Since the flowing electrolyte removes zinc ions away from the anode, the battery described herein avoids the partial saturation of zinc ions and the formation of zinc oxides or dendrites during battery discharging. Thus, the surface of anode is “cleaned” and returned to its “fresh” state after every full discharge, which also prevents the formation of zinc dendrites.

In conventional rechargeable zinc air battery, the reversible reactions are as follows:

Cathode: ½O₂+2e⁻+2H₂O [symbol] 2OH⁻

Anode: Zn+2OH⁻−2e⁻ [symbol] 2ZnO+2H₂O

In the present battery system, the reactions are as follows:

Cathode: ½O₂+2e⁻+H₂O [symbol] 2OH⁻

Anode: Zn+4OH⁻−2e⁻ [symbol] Zn(OH)₄²⁻

As a preferred solution, the charge cathode further comprises particles of at least one transition metal oxide and/or transition metal hydroxide covered on the surface of the electrode to obtain a lower OER potential and to improve the energy efficiency of the battery. The transition metal is preferably selected from Ti, V, Cr, Mn, Fe, Co, Ni, or a combination thereof.

The process of preparing the charging electrode having the transition metal oxide and/or transition metal hydroxide particles covered thereon comprises the following steps. First, the transition metal is deposited by chemical plating or electrochemical plating or by using an acid solution to corrode the electrode. Second, the electrode is heat treated in air to oxidize the surface. Alternatively, the battery may be assembled and the oxygen allowed to oxidize the electrode in an alkaline electrolyte during battery charging.

The present inventors have developed a secondary (i.e. rechargeable) zinc-air battery that addresses at least one of the known deficiencies. In particular, the battery described herein addresses the known problems associated with corrosion of carbon at the cathode and the deterioration of the anode due to zinc dendrite formation. As a result, the battery described herein is capable of operating effectively for extended periods of time (such as for over 4000 hours). Thus, the battery described herein offers a practical, economical and commercially viable zinc-air battery.

### EXAMPLES

### Example A

A tri-electrode single flow zinc air battery was prepared comprising: a piece of 2 cm×3 cm Ni-foam as the charge cathode; a piece of 2 cm×3 cm catalytic air electrode as the discharge cathode; a piece of 2 cm×3 cm copper sheet as the anode; an electrolyte comprising 6 M KOH and 0.4 M K₂Zn(OH)₄; and an electrolyte flow system comprising a pump, a tank, and plastic tubes.

The discharge cathode was prepared by mixing graphite powder, Co₃O₄ (D50=2 um), carbon nanotubes and PTFE (emulsion) in isopropanol to form a slurry. The mass ratios of each component was 65%:10%:5%:20%. The slurry was coated and pressed onto a piece of nickel foam, then dried in an oven. The electrode was roll pressed to a thickness of 0.5 mm, and heat the pressed at 310° C. for 30 min to increase its hydrophobicity.

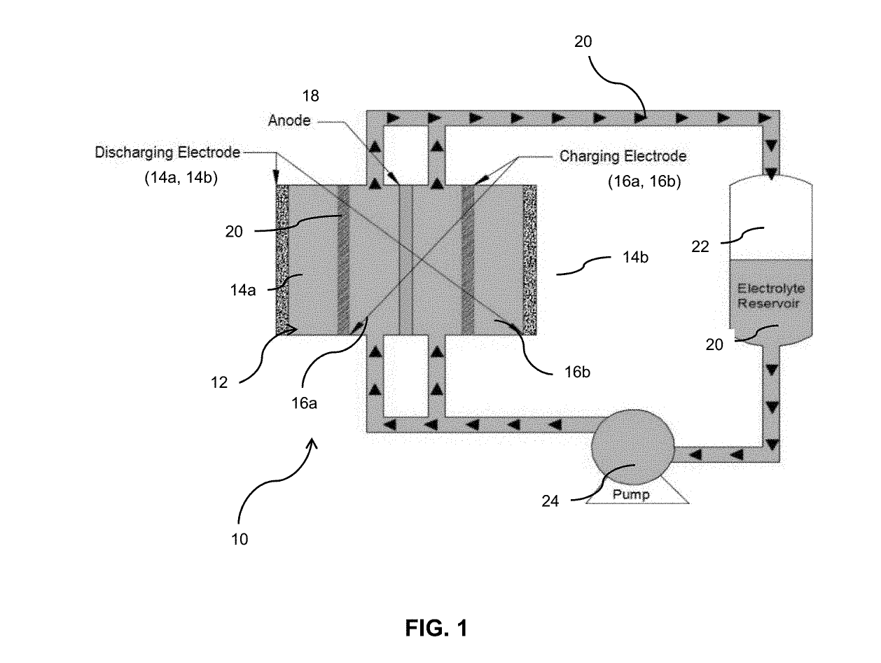

The battery was assembled as shown in FIG. 1. As shown, the battery 10 includes a housing 12 within which is contained two discharge cathodes 14a and 14b, two charge cathodes 16a and 16b and an anode 18. The battery illustrated in FIG. 1 is meant to be illustrative of an aspect of the battery described herein having a pair of discharge cathodes and a pair of charge cathodes. It will be understood that other arrangements of electrodes are possible within the scope of the description as outlined in the appended claims. The housing is adapted to contain a volume of an electrolyte 20 and is associated with, i.e. in fluid communication with, an electrolyte reservoir 22. In order to allow flow of the electrolyte 20 between the reservoir 22 and housing 12, a pump 24 is provided along with suitable piping and manifolds etc.

As can be seen in FIG. 1, one side of each discharge cathode 14a, 14b was exposed to air, i.e. such side was not exposed to electrolyte, and the other side was oriented to face the electrolyte. The charge cathodes were placed between the discharge cathodes and the anode was placed between the charge cathodes. The electrolyte flow system was used to pump the electrolyte to cause a flow between the cell or housing and tank during the battery charging and discharging cycles.

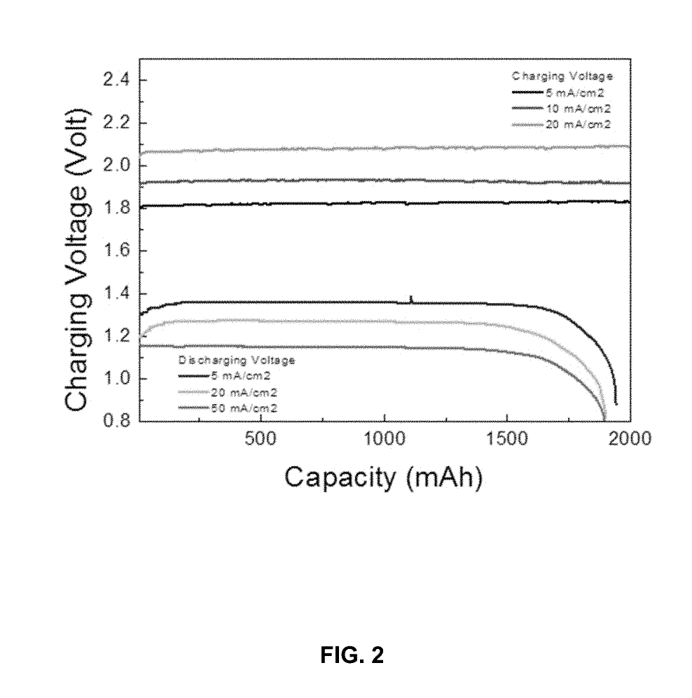

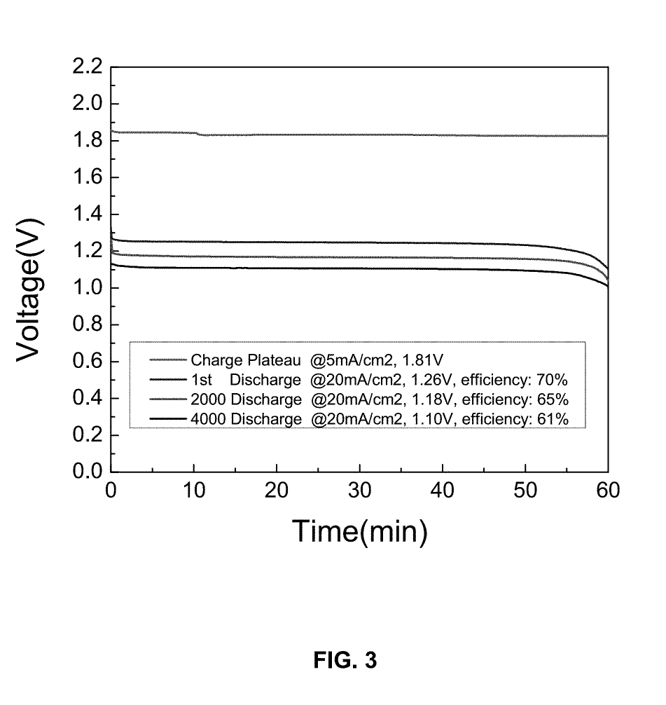

FIGS. 2 and 3 illustrate the performance characteristics of the battery of this example. FIG. 2, illustrates the voltage curves of the battery of Example A at various charging and discharging current densities. FIG. 3 illustrates the cycle performance of the battery. As can be seen in the latter, each charge/discharge cycle lasted 60 mins (1 hour) and the performance of the battery was found to deteriorate very little even after 4000 cycles (i.e. 4000 operating hours).

### Example B

A tri-electrode single flow zinc air battery was assembled as in Example A. The charge cathode was a piece of 0.2 mm thick stainless steel (304) mesh and the discharge cathode comprised graphite powders, MnO₂ (EMD Grade), carbon nanotubes and PTFE, the mass ratio of each component being 65%:10%:5%:20%. The anode was formed from a piece of stainless steel sheet. The electrolyte comprised 4M NaOH and 0.8 M Na₂Zn(OH)₄.

### Example C

A tri-electrode single flow zinc air battery was assembled as in Example A. The charge cathode was a piece of 0.2 mm thick titanium mesh and the discharge cathode comprised a platinum/carbon (Pt/C) catalyst layer sprayed onto the surface of a porous carbon gas diffusion layer. The anode was a piece of copper foam. The electrolyte comprised 8 M KOH and 0.2 M K₂Zn(OH)₄.

### Example D

A tri-electrode single flow zinc-air battery was assembled as in Example A. The charge cathode was a piece of 2 cm×3 cm nickel foam with thickness of 1.5 cm, which was coated by cobalt oxide (CoO) particles.

The CoO-coated piece of nickel foam was prepared by first inserting a piece of nickel foam and a graphite sheet into an aqueous solution comprising 1 M KCL and 0.5 M CoCl₂. The graphite sheet was used as an electroplating cathode, and the nickel foam as an electroplating anode. The process was conducted with a charge having a current density of 20 mA/cm for 15 min to deposit cobalt onto the nickel foam. The foam was then washed and heated at 300° C. for 30 min.

### Example E

A tri-electrode single flow zinc air battery was assembled as in Example A. The charge cathode was a piece of 2 cm×3 cm stainless steel mesh (304) with a thickness of 1.5 cm. The stainless steel mesh was immersed in 3 M HCL solution for 30 min to result in corrosion on its surface. The mesh was then washed and heated at 300° C. for 30 min.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description, but should be given the broadest interpretation consistent with the present specification as a whole. The disclosures of all prior art recited herein are incorporated herein by reference in their entirety.

1. A zinc-oxygen battery comprising:
a housing containing at least one discharge cathode, at least one charge cathode, and at least one anode;
an electrolyte adapted to flow through the housing, the electrolyte comprising an alkaline solution containing at least one zinc salt dissolved therein;
the charge cathode comprising a non-carbon metal mesh and/or metal foam material;
the electrolyte being adapted to flow over at least the surface of the anode.

2. The battery of claim 1, wherein the at least one discharge cathode comprises a conductive, air-permeable catalytic oxygen reduction electrode.

3. The battery of claim 1, wherein the at least one charge cathode comprises an electrolyte permeable and alkaline-resistant metal mesh and/or metal foam material.

4. The battery of claim 1, wherein the at least one anode comprises a conductive, inert electrode adapted to allow zinc deposition during the charging phase and zinc dissolution into the electrolyte during the discharge phase.

5. The battery of claim 1, wherein the at least one charge cathode is formed of nickel, nickel alloy, titanium, titanium alloy, stainless steel, or a mixture or combination thereof.

6. The battery of claim 1, wherein the at least one charge cathode comprises a coating of transition metal oxide particles and/or transition metal hydroxide particles.

7. The battery of claim 1, wherein the at least one anode is in the form of a foil, sheet, plate, or foam.

8. The battery of claim 1, wherein the at least one anode is formed of a carbon/graphite based material, stainless steel, Sn, Pb, Cu, Ag, Au, Pt, alloys thereof, and any combination or mixture thereof.

9. The battery of claim 1, wherein the electrolyte comprises one of NaOH, KOH, LiOH or any mixture thereof.

10. The battery of claim 1, wherein the alkaline concentration is 0.3 to 15 M.

11. The battery of claim 1, wherein the zinc salt is at least one of ZnO, Zn(OH)₂, K₂Zn(OH)₄, Na₂Zn(OH)₄, or any combination thereof.

12. The battery of claim 1, wherein the concentration of the zinc salt is 0.1 to 1.5 M.

13. The battery of claim 1, wherein the electrolyte is contained in an electrolyte reservoir and is pumped through the housing.

14. The battery of claim 13, wherein the housing includes one or more manifolds and/or piping for permitting flow of the electrolyte.

15. The battery of claim 1, wherein a first side of the at least one discharge cathode is exposed to oxygen or air and a second side of the at least one discharge cathode, opposite the first side, is exposed to the electrolyte.

16. The battery of claim 1, wherein the at least one charge cathode is positioned between the at least one discharge cathode and the anode.

17. The battery of claim 1, wherein the battery includes a pair of charge cathodes and a pair of discharge cathodes.

18. The battery of claim 17, wherein the pair of charge cathodes is positioned between the pair of discharge cathodes and the least one anode is positioned between the pair of charge cathodes.
